(19) United States
(12) Patent Application Publication
(10) Pub. No.: US 2025/0086277 A1
(43) Pub. Date: Mar. 13, 2025

(54) SYSTEM AND METHOD FOR DETECTING ABNORMAL DATA

(71) Applicant: SANDS LAB INC., Seoul (KR)

(72) Inventors: Kihong KIM, Seoul (KR); Seongyul EUH, Seongnam-Si, Gyeonggi-Do (KR); Sungeun PARK, Seongnam-Si Gyeonggi-Do (KR); Hyunjong LEE, Seoul (KR)

(73) Assignee: SANDS LAB INC., Seoul (KR)

(21) Appl. No.: 18/580,786

(22) PCT Filed: Aug. 5, 2021
(86) PCT No.: PCT/KR2021/010353

§ 371 Date: Jan. 19, 2024

(30) Foreign Application Priority Data
Jul. 19, 2021 (KR) 10-2021-0094505

(51) Int. Cl. G06F 21/55

(52) U.S. Cl. CPC G06F 21/554; G06F 2221/034

(57) ABSTRACT

The present disclosure relates to an anomaly data detecting system. The anomaly data detecting system includes: one or more trigger modules receiving input data, and when anomaly data is included in the received input data based on a trigger rule, generating one or more initial signals indicating the anomaly data; a signal hub receiving one or more generated initial signals from the one or more trigger modules, and performing a logic operation for the one or more received initial signals based on a feed rule to generate a result signal; and one or more detector modules receiving the generated result signal from the signal hub, and detecting attack detection information corresponding to the anomaly data from the received result signal based on a detector rule.

### TECHNICAL FIELD

The present disclosure relates to a system and a method for anomaly data detection, and particularly, to a system and a method for anomaly data detection which generate a signal for anomaly data and detect an attack associated with the anomaly data.

### BACKGROUND

In recent years, with the development of technology, cyber attacks have also increasingly become intelligent and elaborate. For example, network attacks can disrupt, reject, damage, and destroy networks associated with smartphones or PCs. Therefore, technology for preventing or blocking the network attacks is required.

### SUMMARY

The present disclosure provides a system and a method for anomaly data detection, and a computer program storing a recording medium in order to solve the problem.

The present disclosure may be implemented by various schemes including a system (device), a method, or a computer program stored in a computer readable recording medium.

According to an embodiment of the present disclosure, an anomaly data detecting system includes: one or more trigger modules receiving input data, and when anomaly data is included in the received input data based on a trigger rule, generating one or more initial signals indicating the anomaly data; a signal hub receiving one or more generated initial signals from the one or more trigger modules, and performing a logic operation for the one or more received initial signals based on a feed rule to generate a result signal; and one or more detector modules receiving the generated result signal from the signal hub, and detecting attack detection information corresponding to the anomaly data from the received result signal based on a detector rule.

According to an embodiment of the present disclosure, the trigger rule includes condition information for determining specific data as the anomaly data. The one or more trigger modules include an anomaly evaluation function generation module generating an anomaly evaluation function for determining the anomaly data by using a logic operation and an indentation level associated with the condition information.

According to an embodiment of the present disclosure, the one or more trigger modules further include an anomaly checker module receiving the generated anomaly evaluation function from the anomaly evaluation function generation module, and inputting the input data into the anomaly evaluation function, and when the anomaly data is included in the input data, transmitting an initial signal generation request.

According to an embodiment of the present disclosure, the trigger rule further includes output information associated with a type of generated initial signal. The one or more trigger modules further include a signal generation module generating one or more initial signals of a type determined based on the output information when receiving the initial signal generation request from the anomaly checker module.

According to an embodiment of the present disclosure, the trigger rule includes information associated with a feature of the input data. The one or more trigger modules include a data reception module receiving the input data by using a target protocol from a specific location of a database determined based on the input information.

According to an embodiment of the present disclosure, the feed rule includes relevance information for determining a logic relation between the one or more trigger modules. The signal hub includes a signal operation function generation module generating a signal operation function for generating the result signal based on one or more initial signals by using the logic operation and the indentation level associated with the relevance information.

According to an embodiment of the present disclosure, the signal hub further includes a signal operation module receiving the generated signal operation function from the signal operation function generation module, and generating the result signal by inputting the one or more initial signals into the signal operation function.

According to an embodiment of the present disclosure, the signal hub includes a signal reducer for removing a redundant initial signal among the one or more initial signals.

According to an embodiment of the present disclosure, the signal reducer determines initial signals generated by the same trigger module among the one or more trigger modules as the redundant initial signal.

According to an embodiment of the present disclosure, the signal reducer determines initial signals in which anomaly ranges are redundant at a predetermined rate or more as the redundant initial signal.

According to an embodiment of the present disclosure, the feed rule includes information on a detector module for determining a detector module receiving the generated result signal. The signal hub includes a signal transmission module transmitting the generated result signal to the one or more detector module determined based on the information on the detector module.

According to an embodiment of the present disclosure, the detector rule includes information on a detection rule for extracting attack information associated with the anomaly data. The one or more detector modules include an attack detection function generation module generating an attack detection function for extracting the attack information by using the logical operation and the indentation level associated with the information on the detection rule.

According to an embodiment of the present disclosure, the one or more detector modules further include an attack detector module receiving the generated attack detection function from the attack detection function generation module and inputting the input data associated with the result signal into the attack detection function to perform attack detection for the result signal.

According to an embodiment of the present disclosure, the detector rule includes relevance information between the one or more detector modules for determining whether to process the attack detection information. The one or more detector modules include an evaluation function generation module generating an evaluation function for determining whether to process the attack detection information by using the logical operation and the indentation level associated with the relevance information.

According to an embodiment of the present disclosure, each of the one or more detector modules corresponds to one level among a plurality of levels based on dependence of the detector module. The attack detection information of a previous level of detector module is used by a next-level detector module. The anomaly data detecting system further include an evaluation module receiving the generated evaluation function from the generated evaluation function generation module, and transmitting the attack detection information to the next-level detector module or a backtracker module based on the received evaluation function.

According to an embodiment of the present disclosure, when there is the next-level detector module, the evaluation module transmits the attack detection information to the next-level detector module based on the evaluation function.

According to an embodiment of the present disclosure, when there is no next-level detector module, the evaluation module transmits the attack detection information to the backtracker module.

According to an embodiment of the present disclosure, the anomaly data detecting system further includes: a backtracker module determining an attribute of the attack and a procedure of the attack associated with the anomaly data by using the attack detection information of the one or more detector modules.

According to another embodiment of the present disclosure, an anomaly data detecting method performed by at least one processor includes: receiving input data, and when anomaly data is included in the received input data based on a trigger rule, generating one or more initial signals indicating the anomaly data; receiving the one or more generated initial signals, and performing a logic operation for the one or more received initial signals based on a feed rule to generate a result signal; and receiving the generated result signal, and detecting attack detection information corresponding to the anomaly data from the received result signal based on a detector rule.

According to yet another embodiment of the present disclosure, provided is a computer program stored in a computer readable recording medium to allow a computer to execute the anomaly data detecting method.

According to various embodiment of the present disclosure, an anomaly data detecting system can effectively extract anomaly data included in input data by using a trigger rule, a feed rule, and a detector rule, and analyzes and stores an attack associated with the extracted anomaly data to efficiently respond to a subsequent network attack when being exposed to the subsequent network attack.

According to various embodiment of the present disclosure, the anomaly data detecting system configures a detector module in a hierarchical structure to detect more precise attack detection information.

According to various embodiment of the present disclosure, a signal limitation module can prevent generation of infinite signals for a flooding attack (a network bandwidth exhaustion attack).

According to various embodiment of the present disclosure, the input data is sequentially checked by using an anomaly evaluation function of a tree structure, and as a result, a trigger module can effectively check whether the anomaly data is included in the input data.

According to various embodiment of the present disclosure, front and rear data of the anomaly data is appropriately extracted according to the trigger rule, and as a result, the trigger module can simply extract data in a required range, and effectively generate the same type of data without separate processing.

According to various embodiment of the present disclosure, a signal reducer removes redundancy without using initial signals as it is to enhance a data processing speed and data processing efficiency.

According to various embodiment of the present disclosure, a signal hub can selectively perform an operation for the initial signal received from a target trigger module among a plurality of trigger modules by using a signal operation function of the tree structure.

According to various embodiment of the present disclosure, an evaluation module can determine a level and a connection relationship corresponding to each detector module by using an evaluation function of the tree structure, and gradually perform attack detection more precisely by using a target detector module.

According to various embodiment of the present disclosure, the detector module can effectively detect anomaly data satisfying a specific detection rule among various anomaly data by using an attack detection function of the tree structure.

Effects of the present disclosure are not limited to the aforementioned effects and other unmentioned effects will be clearly understood by those skilled in the art (hereinafter, referred to as “those skilled in the art”) from the disclosure of the claims.

### BRIEF DESCRIPTION OF THE DRAWINGS

Embodiments of the present disclosure will be described below with reference to the accompanying drawings, and here, similar reference numerals represent similar elements, but the present disclosure is not limited thereto.

FIG. 1 is a functional block diagram illustrating an internal configuration of an anomaly data detecting system according to an embodiment of the present disclosure;

FIG. 2 is a functional block diagram illustrating the internal configuration of a trigger module according to an embodiment of the present disclosure;

FIG. 3 is a diagram illustrating an example in which an anomaly evaluation function is generated based on a trigger rule according to an embodiment of the present disclosure;

FIG. 4 is a diagram illustrating an example in which various types of output data are generated based on input data according to an embodiment of the present disclosure;

FIG. 5 is a functional block diagram illustrating the internal configuration of a signal hub according to an embodiment of the present disclosure;

FIG. 6 is a diagram illustrating an example in which a signal operation function is generated based on a feed rule according to an embodiment of the present disclosure;

FIG. 7 is a functional block diagram illustrating the internal configuration of a detector module according to an embodiment of the present disclosure;

FIG. 8 is a diagram illustrating an example in which an evaluation function is generated based on a detector rule according to an embodiment of the present disclosure;

FIG. 9 is a diagram illustrating an example in which an attack detection function is generated based on the detector rule according to an embodiment of the present disclosure;

FIG. 10 is a flowchart illustrating an example of an anomaly data detecting method according to an exemplary embodiment of the present disclosure;

FIG. 11 is a flowchart illustrating an initial signal generating method according to an embodiment of the present disclosure;

FIG. 12 is a flowchart illustrating an example of a result signal generating method according to an embodiment of the present disclosure; and

FIG. 13 is a flowchart illustrating an example of an attack detecting method according to an embodiment of the present disclosure.

### DETAILED DESCRIPTION

Hereinafter, specific contents for carrying out the present disclosure will be described in detail with reference to the accompanying drawings. However, in the following description, if the gist of the present disclosure may be unnecessarily obscure, the specific description of the well-known functions or configurations will be omitted.

In the accompanying drawings, the same or corresponding component is represented by the same reference numeral. Further, in describing the following embodiments, redundantly describing the same or corresponding component may be omitted. However, even though the description of the component is omitted, it is not intended that such a component is not included in any embodiment.

Disclosed advantages and features, and methods for accomplishing the same will be more clearly understood from embodiments described below with reference to the accompanying drawings. The present disclosure is not limited to an embodiment disclosed below but may be implemented in various different shapes and the present embodiment just completes a disclosure of the present disclosure and is provided to completely inform a scope of the present disclosure to those skilled in the art.

Terms used in the present specification will be described in brief and the disclosed embodiment will be described in detail. Terms used in the present specification adopt general terms which are currently widely used as possible by considering functions in the present disclosure, but the terms may be changed depending on an intention of those skilled in the art, a precedent, emergence of new technology, etc. Further, in a specific case, a term which an applicant arbitrarily selects is present and in this case, a meaning of the term will be disclosed in detail in a corresponding description part of the disclosure. Accordingly, the term used in the present disclosure should be defined based on not just a name of the term but a meaning of the term and contents throughout the present disclosure.

A singular expression in the present specification includes a plural expression if there is no clearly singular meaning in the context. Further, the plural expression includes the singular expression if there is no clearly plural meaning in the context. Further, throughout the specification, unless explicitly described to the contrary, the word “includes” will be understood to imply the inclusion of stated elements but not the exclusion of any other elements.

In the present disclosure, the terms “include”, “including”, etc., may indicate that features, steps, operations, elements, and/or components are present, but the terms do not exclude addition of one or more other functions, steps, operations, elements, components, and/or a combination thereof.

In the present disclosure, when it is mentioned that a specific component is “coupled”, “combined”, “connected”, or “react” to another predetermined component, the specific component may be directly coupled, combined, and/or connected, or react to another component, but the present disclosure is not limited thereto. For example, one or more intermediate components may be present between the specific component and another component. Further, in the present disclosure, “and/or” may include one or more respective items listed or a combination of at least some of one or more items.

In the present disclosure, ‘rule’ which includes information for detecting and storing anomaly data associated with a network attack and/or attack detection information for the anomaly data may be created by a predetermined programming language. For example, the rule may include one or more trigger rules, one or more feed rules, and one or more detector rules, but the present disclosure is not limited thereto. Such a rule may be pre-generated by an anomaly data detecting system, a predetermined computing device, etc., or predetermined by a user. According to an embodiment, the trigger rule may include metadata indicating a name a trigger module, a definition of input data, a definition of output data, a definition of a signal limitation function, a definition of an anomaly determination rule, etc. Further, the feed rule may include a definition of a permitted time difference in a logic operation (bool operation) for a signal, names of one or more connected detector modules, one or more connected trigger modules, and a logic operation relation therebetween. Further, the detector rule may include metadata indicating the name of a detector module, the definition of the input data, definitions of one or more detection rules (a category of an alert to be generated, an alert name, an attack procedure step, and an alert determination rule) of the detector module, etc.

In the present disclosure, ‘anomaly data’ may refer to data including different information from a type, a format, etc, of predetermined input data. For example, the anomaly data may include network attack traffic.

In the present disclosure, ‘attack detection information’ may refer to detection information for an attribute, a type, a procedure, etc., of network attack traffic associated with the detected anomaly data. For example, the attribute of the attack may include information on an attack tool, a distribution method, a vulnerability, an attack group, etc.

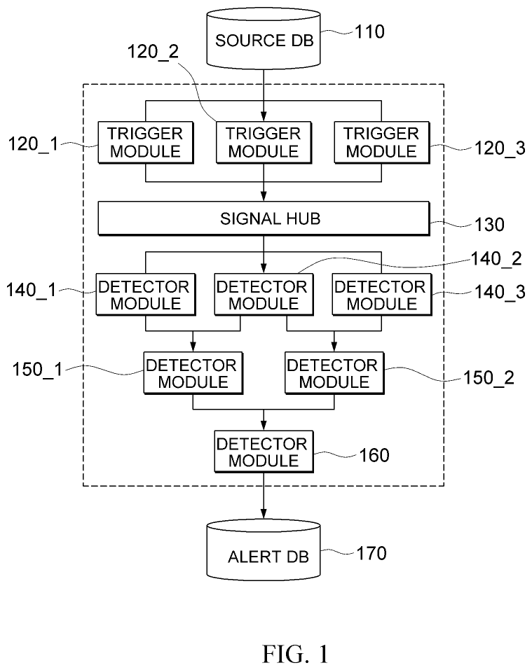

FIG. 1 is a functional block diagram illustrating an internal configuration of an anomaly data detecting system 100 according to an embodiment of the present disclosure. According to an embodiment of the present disclosure, an anomaly data detecting system 100 may refer to a system for extracting anomaly data included in input data (e.g., one or more packets), and detecting an attribute, a procedure, etc., of an attack (e.g., a network attack, etc.) associated with the anomaly data. The anomaly data detecting system 100 may include one or more trigger modules, a signal hub, and one or more detector modules. As illustrated, the anomaly data detecting system 100 may include three trigger modules 120, a signal hub 130, and six detector module 140, 150, and 160, but is not limited thereto, and may include different numbers of modules.

According to an embodiment of the present disclosure, the trigger module 120 may receive the input data from a source DB 110. Here, the source DB 110 may be a database storing predetermined input data which is determination target of anomaly data detection. The source DB 110 may be constituted by one database or constituted by two or more databases which are logically and/or physically divided. The trigger module 120 may receive the input data which becomes the determination target of the anomaly data detection from the source DB 110. For example, the trigger module 120 may receive input data having a specific size according to a specific input cycle by using a specific protocol.

The trigger module 120 may receive the input data and determine whether the received input data is included in the anomaly data based on a trigger rule. According to an embodiment of the present disclosure, the trigger rule may include information on a criterion for determining the anomaly data. Further, the criterion for determining the anomaly data may include a target protocol, the number of retrieved data, a machine learning based anomaly score, the number of SYN packets, a destination IP-specific PPS, a unique number of destination port numbers, etc. The criterion for determining the anomaly data may be predetermined by a user or determined by a predetermined algorithm for determining whether the attack is made. That is, the trigger module 120 may determine whether the anomaly data is included by using the target protocol, the number of retrieved data, the machine learning based anomaly score, the number of SYN packets, the destination IP-specific PPS, the unique number of destination port numbers, etc. For example, when the number of transmission packets of a specific destination port number is 100 or more, the trigger module 120 may determine that the input data includes the anomaly data. In another example, when an anomaly score calculated by machine learning, etc., is 30 or more, the trigger module 120 may determine that the input data includes the anomaly data.

When determining that the input data includes the anomaly data, the trigger module 120 may generate one or more initial signals indicating the anomaly data. Here, the initial signal may refer to data associated with at least a partial region of the input data including a region corresponding to the anomaly data. According to an embodiment of the present disclosure, the trigger rule may include output information associated with the type of initial signal, and the trigger module 120 may generate one or more initial signals of a type determined based on the output information. For example, a first trigger module 120_1 may generate a first initial signal, a second trigger module 120_2 may generate a second initial signal, and a third trigger module 120_3 may generate a third initial signal. The generated initial signals may be transferred to the signal hub 130.

According to an embodiment of the present disclosure, the signal hub 130 may perform an operation for the initial signals received from the trigger module 120. Specifically, the signal hub 130 may generate a result signal by performing the operation for the received initial signals based on a feed rule. For example, the signal hub 130 removes the redundancy for the initial signals received from the trigger module 120, and performs a logic operation (e.g., a Bool operation) to generate the result signal. That is, the feed rule may include information on the logic operation to be performed for the initial signals, and the signal hub 130 may perform the operation based on the information on the logic operation included in the feed rule. Here, the result signal as data (e.g., data acquired by merging the initial signals) associated with the initial signals which becomes the target of the logic operation may refer to data including all time ranges of the initial signals. The generated result signal may be transferred to the detector modules 140, 150, and 160.

According to an embodiment of the present disclosure, the detector modules 140, 150, and 160 may receive the generated result signal from the signal hub 130, and detect attack detection information corresponding to the anomaly data from the received result signal based on the detector rule. For example, the detector rule may include information on an attack detection rule for determining the attack corresponding to the anomaly data. Here, the information on the attack detection rule may include information for determining the attribute, the procedure, etc., of the attack by analyzing or examining the machine learning based anomaly score, the number of data or the number of specific fields, a protocol of a packet, a link inventory, a protocol inventory of a link, an IP blacklist, a domain blacklist, a URL blacklist, an mac address inventory, an IP address inventory, the number of SYN packets, the destination IP-specific PPS, the unique number of destination pot numbers, etc. That is, the detector modules 140, 150, and 160 may detect the attack detection information (e.g., the attribute, the procedure, etc., of the attack) corresponding to the anomaly data by using the detector rule. The detected attack detection information may be stored in a warning DB 170.

According to an embodiment, the anomaly data detecting system 100 compares the detected attack detection information and the existing detected attack (a name, a category, etc., of the attack) to determine a specific attack corresponding to the attack detection information. Then, the anomaly data detecting system 100 may block or prevent the relevant attack by using a determined response method of the attack. When the corresponding attack is not discovered among the existing detected attacks, the anomaly data detecting system 100 may define the detected attack detection information as a new attack, and store and manage a distribution method, a vulnerability, etc., of the relevant attack in a predetermined database (e.g., the warning DB 170). In other words, when a new network attack is also executed in addition the existing attack, the anomaly data detecting system 100 analyzes the new network attack in real time to determine related information and a countermeasure.

Additionally or alternatively, the anomaly data detecting system 100 may perform a simulation for an attack and a response using a newly defined attack. For example, the anomaly data detecting system 100 repeatedly performs the attack and the response using the newly defined attack to determine a response vulnerability, etc. Then, the anomaly data detecting system 100 may continuously enhance a response performance by changing a numerical values, an algorithm, etc., for the determined response vulnerability. Additionally or alternatively, the anomaly data detecting system 100 may analyze a latest attack trend by using newly defined predetermined number of attacks. Here, the attack trend may include predetermined information on the latest attack, such as the distribution method, the vulnerability, etc., of the attack. In this case, a predetermined algorithm for analyzing and determining the trend of the attack may be used.

According to an embodiment, the detector modules 140, 150, and 160 may correspond to one level of a plurality of levels based on dependence. Here, the dependence may be determined differently according to the type of input value of each detector module. For example, a first level of detector module 140 may refer to a module that receives the result signal directly from the signal hub 130 and generates the attack detection information. Further, a second level of detector module 150 may refer to a module that regenerates the attack detection information by using an output value of the first level of detector module 140 as a new input value and a third level of detector module 160 may refer to a module that regenerates the attack detection information by using the output value of the second level of detector module 150 as the new input value. In other words, the attack detection information of a previous level of detector module may be used by a next level of detector module. The levels of the detector modules 140, 150, and 160 may be determined based on relevance information among one or more detector modules 140, 150, 160 included in the detector rule.

In FIG. 1, it is described above that the anomaly data detecting system 100 receives the input data from the source DB 110, but the present disclosure is not limited thereto. For example, the anomaly data detecting system 100 may also receive the input data from a predetermined external apparatus (e.g., a user terminal, an information processing system, etc.). Further, in FIG. 1, the trigger module 120, the signal hub 130, and the detector modules 140, 150, and 160 are separately described, but this is just for assisting the understanding of the present disclosure, and one operation device may also perform two or more functions. By such a configuration, the anomaly data detecting system 100 can effectively extract anomaly data included in input data by using a trigger rule, a feed rule, and a detector rule, and analyzes and stores an attack associated with the extracted anomaly data to efficiently respond to a subsequent network attack when the subsequent network attack occurs. Further, the anomaly data detecting system 100 configures the detector modules 140, 150, and 160 in a hierarchy structure to detect more precise attack detection information. Further, the anomaly data detecting system 100 simply analyzes a newly discovered attack in addition to the anomaly data associated with the network attack through the above-described process to efficiently perform the response to the relevant attack later.

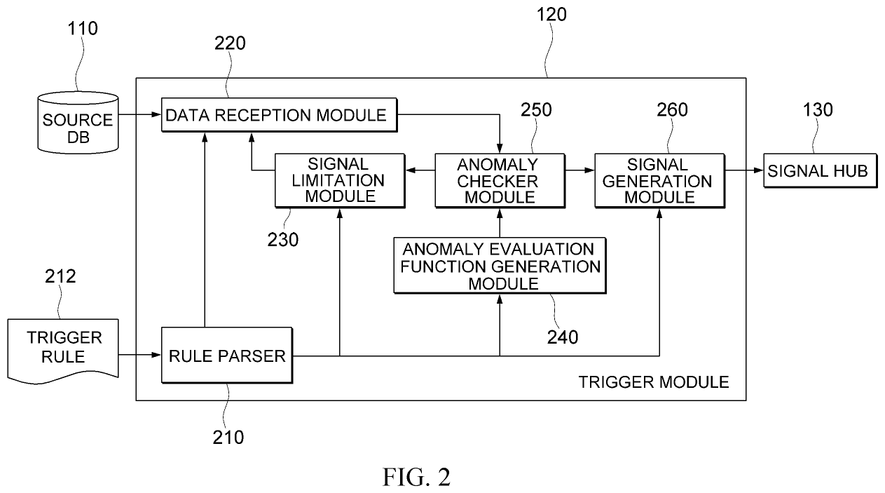

FIG. 2 is a functional block diagram illustrating the internal configuration of a trigger module 120 according to an embodiment of the present disclosure. As illustrated, the trigger module 120 may include one or more detailed modules. For example, the trigger module 120 may include a rule parser 210, a data reception module 220, a signal limitation module 230, an anomaly evaluation function generation module 240, an anomaly checker module 250, and a signal generation module 260. Further, the trigger module 120 may communicate with the source DB 110, the signal hub 130, etc., and send and receive data and/or information required for the anomaly data detection.

The rule parser 210 may receive, and analyze and/or process a trigger rule 212. For example, the rule parser 210 may receive and analyze the trigger rule 212 from one or more external apparatuses, and perform processing for determining the operation of each detailed module included in the trigger module 120. According to an embodiment, the trigger rule 212 may include input information associated with a feature of the input data, and the rule parser 210 may set or determine the feature of the input data by using the input information. For example, the rule parser 210 may set or determine the feature of the input data by using the input information including an index of the received input data, a target protocol used for receiving the input data, a size of the input data, a reception cycle of the input data etc., based on the trigger rule 212. Information on the determined feature of the input data may be transmitted to the data reception module 220.

Additionally or alternatively, the rule parser 210 may limit the number of signals for a predetermined time, which are generated for efficient processing of data and/or information. According to an embodiment, the trigger rule 212 may include information on a specific time range and the number of signals which is enabled to be generated and/or processed within the relevant time range. In this case, the rule parser 210 may set or determine the limitation of the signal by using the relevant information. Information on the determined limitation of the signal may be transmitted to the signal limitation module 230.

Additionally or alternatively, the rule parser 210 may set or determine a condition for detecting the anomaly data. As described above, the trigger rule 212 may include condition information associated with the detection of the anomaly data by using the target protocol, the number of retrieved data, the machine learning based anomaly score, the number of SYN packets, the destination IP-specific PPS, the unique number of destination port numbers, etc. That is, the rule parser 210 may determine the information for detecting the anomaly data based on the condition information included in the trigger rule 212. The determined information for detecting the anomaly data may be transmitted to the anomaly evaluation function generation module 240.

Additionally or alternatively, the rule parser 210 may set or determine the type of the output data (e.g., the initial signal). For example, the trigger rule 212 may include information associated with the type, the size, the range, etc., of the output data. That is, the rule parser 210 may determine the information on the type, etc., of the output data based on the trigger rule 212. The determined information on the type, etc., of the output data may be transmitted to the signal generation module 260.

According to an embodiment, the data reception module 220 may receive the information on the feature of the input data, and receive the input data by using the target protocol from a specific location of the determine database. For example, when the index of the input data is “traffic”, the target protocol is “tcp”, the reception cycle is 5 s, and the size of the input data is 10 s, the data reception module 220 may receive input data corresponding to “traffic” with the size of 10 s at the reception cycle of 5 s by using the protocol of “tcp” from the database (e.g., the source DB). Then, the data reception module 220 may transmit the received input data to the anomaly checker module 250.

According to an embodiment, the anomaly checker module 250 receives the anomaly evaluation function generated by the anomaly evaluation function generation module 240 and inputs the input data into the anomaly evaluation function to determine whether the anomaly data is included in the input data. For example, the anomaly evaluation function generation module 240 may generate the anomaly evaluation function for determining the anomaly data by using a logic operation and an indentation level associated with the condition information (e.g., information for detecting the anomaly data determined based on the condition information). Here, the anomaly evaluation function may be generated as a tree-structure function. That is, the anomaly checker module 250 may determine whether the anomaly data is included in the input data by using the tree-structure anomaly evaluation function.

When it is determined that the anomaly data is present, the anomaly checker module 250 may transmit an initial signal generation request to the signal generation module 260. Further, the anomaly checker module 250 may transmit an initial signal generation notification to the signal limitation module 230. According to an embodiment, the number of signals may be adjusted or limited by using information on the number of initial signal generation notifications received from the anomaly checker module 250 and the limitation of the signal. For example, the signal limitation module 230 may control only a specific number of (e.g., 1) signals to be generated for a specific time (e.g., 120 seconds), and when signals of a number which is equal to the specific number or more than the specific number are generated within the specific time, the signal limitation module 230 may limit the reception of the input data by deactivating the data reception module 220. Then, the signal limitation module 230 may activate the data reception module 220 again, and initialize the number of signals when the specific time elapsed. By such a configuration, the signal limitation module 230 may prevent generation of infinite signals for a flooding attack (a network bandwidth exhaustion attack).

When receiving the initial signal generation request, the signal generation module 260 may generate the initial signal based on the received initial signal generation request and the information on the output data type. For example, when the type of initial signal is determined as “input”, the signal generation module 260 outputs the input data as it is to generate the initial signal. In another example, when the type of initial signal is determined as “anomaly”, the signal generation module 260 makes data within a specific range be included based on the input data to generate the initial signal. Here, the initial signal may include a name and a version of the trigger module 120, the name of the index of the database, the name of the target protocol, a start time of the output data, an end time of the output data, etc. The generated initial signal may be transmitted to the signal hub 130 for next processing.

In FIG. 2, it is illustrated that the signal hub 130 receives the initial signal generated from one trigger module 120, but the present disclosure is not limited thereto, and the signal hub 130 may receive initial signals generated from a plurality of trigger modules. Further, in FIG. 2, respective modules included in the trigger module 120 are separately described, but this is just for assisting the understanding of the present disclosure, and one operation device may also perform two or more functions.

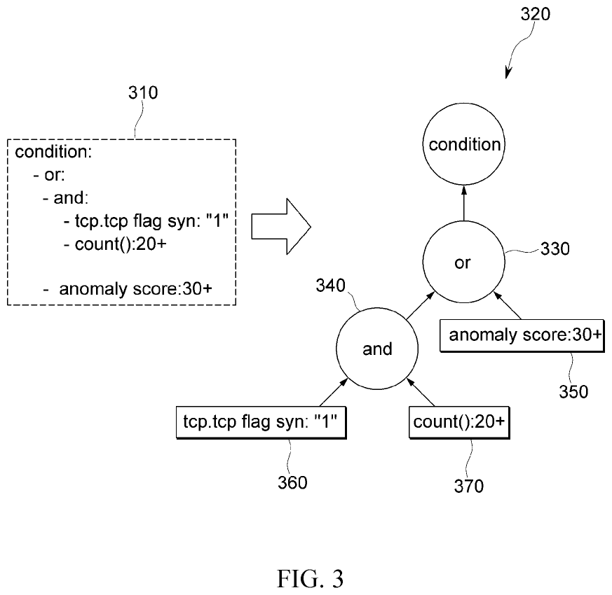

FIG. 3 is a diagram illustrating an example in which an anomaly evaluation function 320 is generated based on a trigger rule according to an embodiment of the present disclosure. As described above, the trigger module (or the anomaly evaluation function generation module) may generate the anomaly evaluation function 320 by using the trigger rule (at least a part of the trigger rule). For example, the trigger rule may include condition information 310 for determining specific data as the anomaly data, and the trigger module may generate an anomaly evaluation function for determining the anomaly data by using the logic operation and the indentation level associated with the condition information.

In the illustrated example, the trigger module may define a bool relation of the condition information 310 by using the bool operation and the indentation level. For example, a “tcp.tcp_flag_syn: 1” syntax 360 and a “count( ):20+” syntax 370 may be connected by an and operation 340, and the connected and operation 340 and an “anomaly_score: 30+” syntax 350 may be connected by an or operation 330. That is, the trigger module constructs the bool relation of the condition information in the tree structure to generate the abnormal evaluation function 320.

According to an embodiment, the trigger module may determine whether the anomaly data is included in the input data by using the generated anomaly evaluation function 320. For example, the trigger module may determine whether the anomaly data is included in the input data by detecting the tree type anomaly evaluation function 320 based on a postorder, but is not limited thereto. The trigger module may also detect the anomaly evaluation function 320 by using a preorder, an inorder, etc.

In the illustrated example, when the input data is received, if the number of packets in which tcp.tcp_flag_syn is 1 is 20 or more or the anomaly score is 30 or more, the trigger module may determine that the relevant input data includes the anomaly data. As such, the input data is sequentially checked by using the anomaly evaluation function 320 of the tree structure, and as a result, the trigger module may effectively check whether the anomaly data is included in the input data.

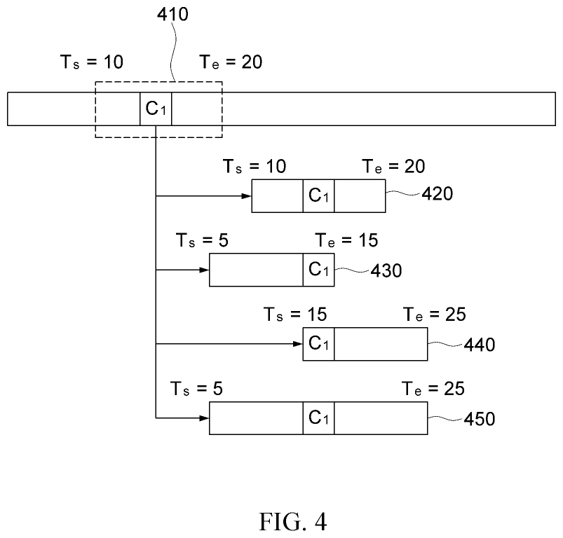

FIG. 4 is a diagram illustrating an example in which various types of output data 420, 430, 440, and 450 are generated based on input data 410 according to an embodiment of the present disclosure. As described above, when anomaly data C1 is included in the input data 410, the trigger module (or signal generation module) may generate the output data 420, 430, 440, and 450 (e.g., the initial signal) including the anomaly data. For example, in respect to the output data 420, 430, 440, and 450, the type, etc., may be determined based on the output information included in the trigger rule.

According to an embodiment, the trigger rule may include information on the type, the size, a unit, a cover, etc., of the output data. Here, the type may be determined as input or anomaly, and the size may indicate a time interval of the output data. Further, the cover may determine a region including the output data. For example, when the type is input, the trigger module may generate or output the output data 420 which is the same as the input data 410 as the initial signal. In another example, when the type is anomaly and the cover is before, the trigger module may generate or output the output data 430 as the initial signal so as to further include a region of a previous time interval based on the anomaly data C1. In yet another example, when the type is anomaly and the cover is after, the trigger module may generate or output the output data 440 as the initial signal so as to further include a region of a next time interval based on the anomaly data C1. In still yet another example, when the type is anomaly and the cover is both, the trigger module may generate or output the output data 450 as the initial signal so as to further include the regions of the previous and next time intervals based on the anomaly data C1. By such a configuration, front and rear data of the anomaly data is appropriately extracted according to the trigger rule, and as a result, the trigger module may simply extract data in a required range, and effectively generate the same type of data without separate processing.

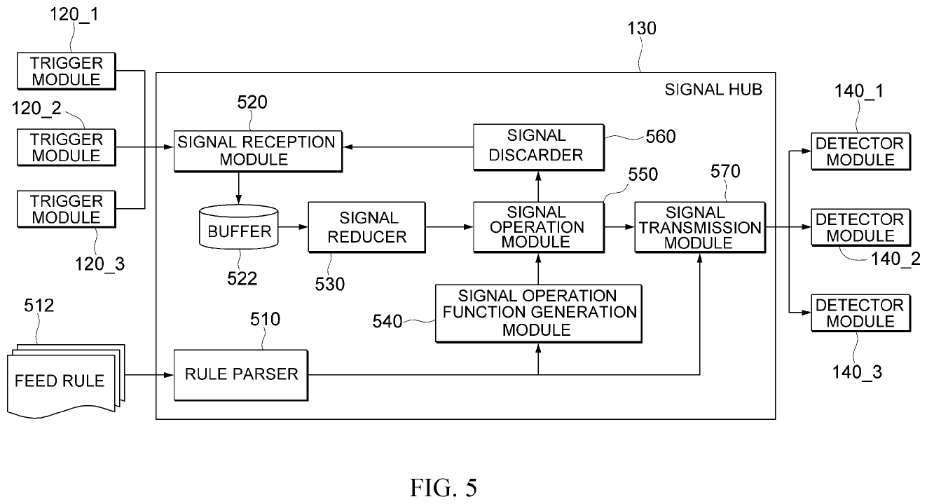

FIG. 5 is a functional block diagram illustrating the internal configuration of a signal hub 130 according to an embodiment of the present disclosure. As illustrated, the signal hub 130 may include one or more detailed modules. For example, the signal hub 130 may include a rule parser 510, a signal reception module 520, a signal reducer 530, a signal operation function generation module 540, a signal operation module 550, a signal discarder 560, and a signal transmission module 570. Further, the signal hub 130 may communicate with the trigger module 120, the detector module 140, etc., and send and receive data and/or information required for the anomaly data detection.

The rule parser 510 may receive, and analyze and/or process a feed rule 512. For example, the rule parser 510 may receive and analyze the feed rule 512 from one or more external apparatuses, and perform processing for determining the operation of each detailed module included in the signal hub 130. According to an embodiment, the feed rule 512 may include relevance information for determining a logical relation between one or more trigger modules. Here, one or more trigger modules may include a plurality of trigger modules. Further, the relevance information may include a bool operation relation between the plurality of trigger modules. That is, the rule parser 510 may analyze the bool operation relation between the plurality of trigger modules based on the relevance information. Information on the analyzed bool operation relation between the plurality of trigger modules may be transmitted to the signal operation function generation module 540.

Additionally or alternatively, the feed rule 512 may include information on one or more detector modules 140 which are to receive the operated result signal, and the rule parser 510 may determine a list of one or more detector modules 140 which are to receive the operated result signal by using the feed rule 512. The determine list of one or more detector modules 140 may be transmitted to the signal transmission module 570.

According to an embodiment of the present disclosure, the signal reception module 520 may receive the initial signals generated from the trigger module 120. For example, the signal reception module 520 may receive the initial signals generated from all defined trigger modules 120. In this case, the received initial signals may be stored in a buffer 522 in a reach order. The stored initial signals may be stored in the buffer 522 until the initial signals are processed by the signal reducer 530.

The signal reducer 530 may receive the initial signals stored in the buffer 522, and then remove a redundant initial signal among the received initial signals. For example, the signal reducer 530 may remove the redundant initial signal by receiving the initial signals at a cycle of a predetermined time. According to an embodiment, the signal reducer 530 may determine initial signals generated by the same trigger module among one or more trigger modules 120 as the redundant initial signal. Additionally or alternatively, the signal reducer 530 may determine initial signals in which the anomaly range is redundant at a predetermined rate or more as the redundant initial signal. For example, when the predetermined rate is 50%, if a first initial signal is a signal in a range of 5 s to 25 s, and a second initial signal is a signal in a range of 10 s to 30 s, the first and second initial signals may be determined as the initial signal in which the anomaly range is redundant at the predetermined rate or more. Then, the signal reducer 530 may remove the initial signal (the remaining initial signals other than one initial signal among the redundant initial signals) determined to be redundant, and then transfer the remaining initial signals to the signal operation module 550. In this case, the signal reducer 530 may group the initial signals according to the name of the trigger module 120 and transfer the grouped initial signals to the signal operation module 550. By such a configuration, the signal reducer 530 removes redundancy without using initial signals as it is to enhance a data processing speed and data processing efficiency.

The signal operation module 550 receives the signal operation function generated from the signal operation function generation module 540, and inputs one or more initial signals into the signal operation function to generate the result signal. For example, the signal operation function generation module 540 may generate the signal operation function for generating the result signal based on one or more initial signals by using the logic operation and the indentation level associated with the relevance information. Here, the signal operation function may be generated as the tree-structure function. That is, the signal operation module 550 may perform the operation for the received initial signals by using the tree-structure signal operation function. Further, the signal operation module 550 may record by which feed rule among a plurality of feed rules the operation is performed for each initial signal.

When processing all initial signals is completed, the signal operation module 550 may transfer the result signal transmission request to the signal transmission module 570. Further, the signal operation module 550 may request the signal discarder 560 to process the signal. According to an embodiment, the signal discarder 560 may receive the initial signals from the signal operation module 550. For example, the signal discarder 560 may received the grouped initial signals. When receiving the initial signals, the signal discarder 560 may delete the initial signal of which processing is completed by all feed rules, and since the initial signal of which processing is not completed by all feed rules should be processed later, the relevant initial signal may be stored. Further, when a time difference between a received last initial signal and the signal which not processed is larger than a distance difference value defined by the feed rule, the relevant initial signal is not processed even later, the signal discarder 560 may discard the relevant initial signal. Here, the stored initial signal may be transferred to the signal reducer 530 and the signal operation module 550 through the signal reception module 520 and the buffer 522 again. That is, the process may be repeatedly performed until processing all initial signals is completed.

The signal transmission module 570 may transmit the generated result signal to one or more determined detector modules 140 by using the received result signal and the information on the detector module received from the rule parser 510. Here, the result signal transmitted to the detector module 140 may include the name and the version of the trigger module 120, the name of the index of the database, the name of the target protocol, the start time of the output data, the end time of the output data, etc., for the initial signal used for the operation. In this case, the detector module 140 receiving the result signal from the signal transmission module 570 may be a detector level of a first level.

In FIG. 5, it is illustrated that the initial signals are received from three trigger modules 120 and the result signals are transmitted to three detector modules 140, but the present disclosure is not limited thereto, and the initial signals may be received from a predetermined number of trigger modules and the result signals may be transmitted to a predetermined number of detector modules. Further, in FIG. 5, respective modules included in the signal hub 130 are separately described, but this is just for assisting the understanding of the present disclosure, and one operation device may also perform two or more functions.

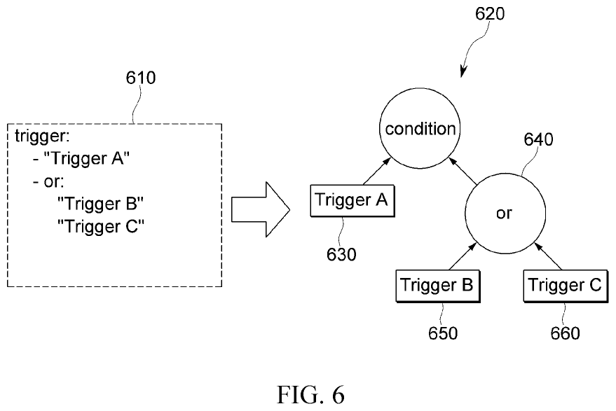

FIG. 6 is a diagram illustrating an example in which a signal operation function 620 is generated based on a feed rule according to an embodiment of the present disclosure. As described above, the signal hub (or the signal operation function generation module) may generate a signal operation function 620 by using the feed rule (at least a part of the feed rule). For example, the feed rule may include relevance information 610 for determining the logic relation between one or more trigger modules, and the signal hub may generate the signal operation function 620 for generating the result signal based on one or more initial signals by using the logic operation and the indentation level associated with the relevance information 610.

In the illustrated example, the signal hub may define a bool relation of the relevance information 610 by using the bool operation and the indentation level. For example, a “Trigger B” syntax 650 and a “Trigger C” syntax 660 may be connected by an or operation 640, and the connected or operation 640 and a “Trigger A” syntax 630 may be connected by an and operation. That is, the signal hub constructs the bool relation of the relevance information 610 in the tree structure to generate the signal operation function 620. Here, when the syntaxes are connected by the and operation, the signal hub may perform the operation if all initial signals reach from the relevant trigger module. Further, when the syntaxes are connected by the or operation, the signal hub may immediately perform the operation if the initial signals reach from one or more trigger modules.

According to an embodiment, the signal hub may determine whether the initial signals are transferred from the trigger modules to be operated by using the generated signal operation function 620, and generate the result signal. For example, the signal hub may determine whether the initial signals are operation targets by detecting the tree type signal operation function 620 based on the postorder, and generate the result signal by using the relevant initial signals when the initial signals are the operation targets, but the present disclosure is not limited thereto. The signal hub may also detect the signal operation function 620 by using the preorder, the inorder, etc. Additionally, the feed rule may include a distance setting value, and when determining whether the initial signals are the operation targets, the signal hub may determine whether the initial signals are the operation targets based on whether a difference between ranges of the initial signals is within the distance setting value.

In the illustrated example, when the signal hub receives the initial signal from any one of Trigger B or Trigger C and additionally receives the initial signal from Trigger A, the signal hub may generate the result signal by using the received initial signals. Here, the result signal may include time ranges of the initial signals which are the operation targets. By such a configuration, the signal hub can selectively perform an operation for the initial signal received from a target trigger module among a plurality of trigger modules by using the signal operation function 620 of the tree structure.

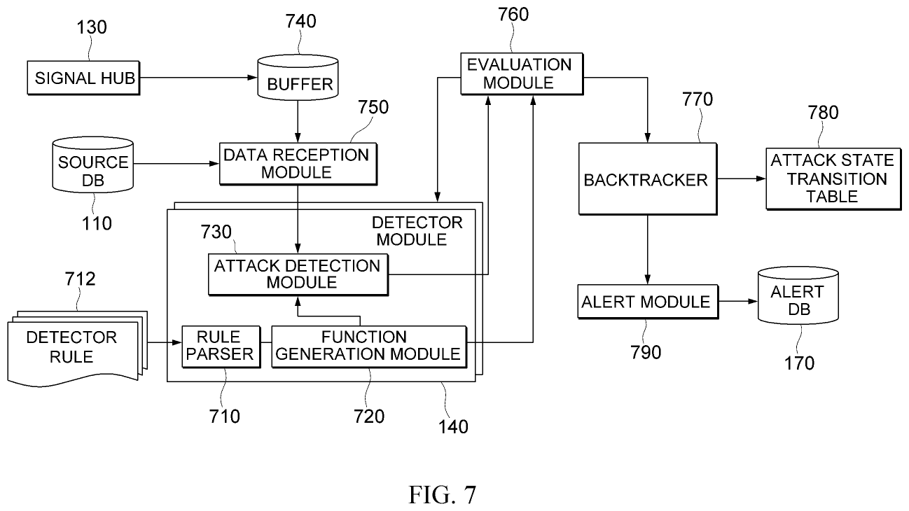

FIG. 7 is a functional block diagram illustrating the internal configuration of a detector module 140 according to an embodiment of the present disclosure. As illustrated, the detector module 140 may include one or more detailed modules. For example, the detector module 140 may include a rule parser 710, a function generation module 720, and an attack detection module 730. Here, the detector module 140 may correspond to one level among a plurality of levels according to an input value received by the detector module 140. Further, the detector module 140 may communicate with another module component of the anomaly data detecting system, and send and receive data and/or information required for the anomaly data detection.

The rule parser 710 may receive, and analyze and/or process a detector rule 712. For example, the rule parser 710 may receive and analyze the detector rule 712 from one or more external apparatuses, and perform processing for determining the operation of each detailed module included or connected in the detector module 140. According to an embodiment, the detector rule 712 may include information on a detection rule for extracting attack information associated with the anomaly data. In this case, the rule parser 710 may analyze the logic operation relation of the information on the detection rule, and transfer the logical operation relation to the function generation module 720. Additionally or alternatively, the detector rule 712 may include relevance information between one or more detector modules 140 for determining whether to process the attack detection information. In this case, the rule parser 710 may analyze the logic operation relation of the relevance information, and transfer the logical operation relation to the function generation module 720.

According to an embodiment, the result signal transferred from the signal hub 130 may be stored in a buffer 740. In this case, the data reception module 750 may read and process the result signal stored in the buffer 740. For example, the data reception module 750 may inquire data stored in the source DB 110 by using index information and target protocol information included in the result signal. The data reception module 750 may transfer the result signal and/or the inquired data to the detector module (the first-level detector module) 140.

According to an embodiment, the attack detection module 730 receives the attack detection function generated from the function generation module 720, and inputs the input data associated with the result signal into the attack detection function to perform attack detection for the result signal. For example, the function generation module 720 may generate the attack detection function for extracting the attack information by using the logical operation and the indentation level associated with the information on the detection rule. Here, the attack detection function may be generated as the tree-structure function. That is, the attack detection module 730 may perform the attack detection for the result signal by using the tree-structure attack detection function. When the detection is completed by the attack detection module 730, a detection history may be stored, and the attack detection information including the detection history and the name of the relevant detector module 140 may be transferred to an evaluation module 760.

The evaluation module 760 may receive the evaluation function generated from the function generation module 720, and transmit the attack detection information to the next-level detector module or a backtracker module 770 based on the received evaluation function. For example, the detector rule 712 may include relevance information between one or more detector modules for determining whether to process the attack detection information, and the function generation module 720 may generate an evaluation function for determining whether to process the attack detection information by using the logic operation and the indentation level associated with the relevance information. According to an embodiment, when there is the next-level detector module, the evaluation module 760 may transmit the attack detection information to the next-level detector module based on the evaluation function. Additionally or alternatively, when there is no next-level detector module, the evaluation module 760 may transmit the attack detection information to the backtracker module 770.

The backtracker module 770 may determine the attribute of the attack and the procedure of the attack associated with the anomaly data by using the attack detection information of one or more detector modules. According to an embodiment, the backtracker module 770 may analyze the attribute of the attack and/or a lifecycle of the attack by analyzing the detection information and history recorded when the attacks are detected in the attack detection modules of the respective detector modules. For example, the attack attribute for the final attack detection may be the name of a category of a detected alert, and the attack procedure may be configured by connecting attack states of activated detector modules. Here, the backtracker module 770 may receive information on a previous attack procedure state from an attack state switching table 780, and when it is possible to connect a previous attack state and a current attack state, the backtracker module 770 may configure the attack procedure (sequence) or when it is impossible to connect the previous attack state and the current attack state, the backtracker module 770 may configure a new attack procedure. The detected attack detection information, attack attribute, attack procedure, etc., may be transmitted to an alert module 790, and the alert module 790 may store the detected information in the alert DB 170.

In FIG. 7, it is described above that the function generation module 720 generates the attack detection function and the evaluation function, but the present disclosure is not limited thereto, and a module for generating the attack detection function and a module for generating the evaluation function may be separately present. Further, in FIG. 7, respective modules included in or connected to the detector module 140 are separately described, but this is just for assisting the understanding of the present disclosure, and one operation device may also perform two or more functions.

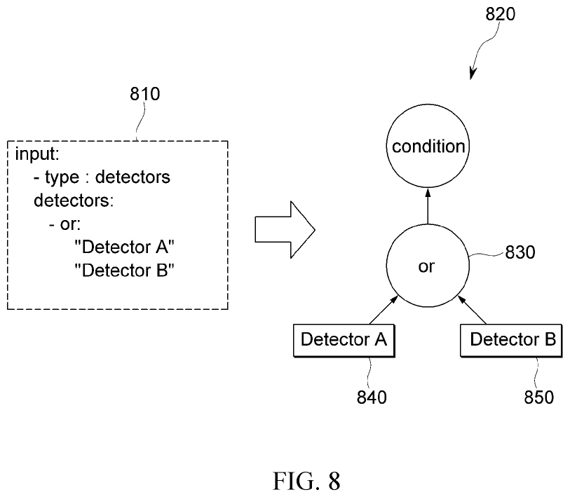

FIG. 8 is a diagram illustrating an example in which an evaluation function 820 is generated based on a detector rule according to an embodiment of the present disclosure. As described above, the detector module (the evaluation function generation module of the detector module) may generate an evaluation function 820 by using the detector rule (at least a part of the detector rule). For example, the detector rule may include relevance information 810 between one or more detector modules for determining whether to process the attack detection information, and the detector module may generate an evaluation function 820 for determining whether to process the attack detection information by using the logic operation and the indentation level associated with the relevance information 810.

In the illustrated example, the type of input may be determined as signal or detectors. When the input type is the signal, the detector module receives result signal directly for the signal hub, so the evaluation function 820 may not be used. In other words, the evaluation function 820 may be used when the attack detection information is received from the detector module as an input value. The detector module may define the bool relation of the relevance information 810 by using the bool operation and the indentation level. For example, a “Detector A” syntax 840 and a “Detector B” syntax 850 may be connected by an or operation 830. That is, the detector module constructs the bool relation of the relevance information 810 in the tree structure to generate the evaluation function 820. The generated evaluation function 820 may be transmitted to an evaluation module.

The evaluation module may check whether there is the next-level detector module by using the evaluation function 820. When there is the next-level detector module, the evaluation module may transmit the attack detection information of the previous-level detector module to the next-level detector module. When there is no next-level detector module, the evaluation module may analyze the feature, the procedure, etc., of the attack by transmitting the attack detection information to the backtracker module. For example, when the syntaxes are connected by the and operation, the evaluation module may perform the processing if all attacks are detected from the relevant detector modules. Further, when the syntaxes are connected by the or operation, the evaluation module may immediately perform the processing if the attacks are detected from one or more detector modules.

In the illustrated example, when the evaluation module receives the attack detection information including the detection history, etc., from any one of Detector A or Detector B, the evaluation module may check whether there is the next-level detector module and perform processing therefor. By such a configuration, the evaluation module can determine a level and a connection relationship corresponding to each detector module by using the evaluation function 820 of the tree structure, and gradually perform attack detection more precisely by using a target detector module.

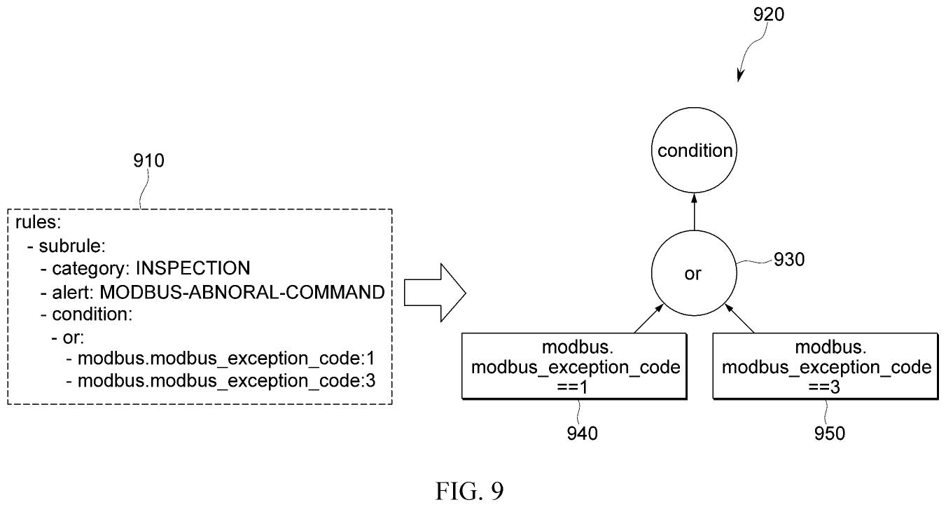

FIG. 9 is a diagram illustrating an example in which an attack detection function 920 is generated based on the detector rule according to an embodiment of the present disclosure. As described above, the detector module (or the attack detection function generation module) may generate an attack detection function 920 by using the detector rule (at least a part of the detector rule). For example, the detector rule may include information 910 on the detection rule for extracting the attack information associated with the anomaly data, and the detector module may generate the attack detection function 920 for extracting the attack information by using the logic operation and the indentation level associated with the information 910 on the detection rule.

In the illustrated example, the information 910 on the detection rule may include information on a category of an alert to be generated, a name of the alert to be generated, an attack procedure step in which the alert may be generated, etc. The detector module may define the bool relation of the information 910 on the detection rule by using the bool operation and the indentation level. For example, a “modbus.modbus_exception_code==1” syntax 940 and a “modbus.modbus_exception_code==3” syntax 950 may be connected by an or operation 930. That is, the detector module constructs the information 910 on the detection rule in the tree structure to generate the attack detection function 920.

According to an embodiment, the detector module may determine the result signal and/or the attribute, the procedure, etc., of the attack included in previous-level attack detection information b using the attack detection function 920. For example, when the input data modbus.modbus_exception_code is 1 or 3, the detector module may detect the attribute, the procedure, etc., of the attack associated with the relevant condition. For example, the detector module may detect the attribute, the procedure, etc., of the attack by detecting the tree type attack detection function 920 based on the postorder, but the present disclosure is not limited thereto. The detector module may also detect the attack detection function 920 by using the preorder, the inorder, etc. By such a configuration, the detector module can effectively detect anomaly data satisfying a specific detection rule among various anomaly data by using the attack detection function 920 of the tree structure.

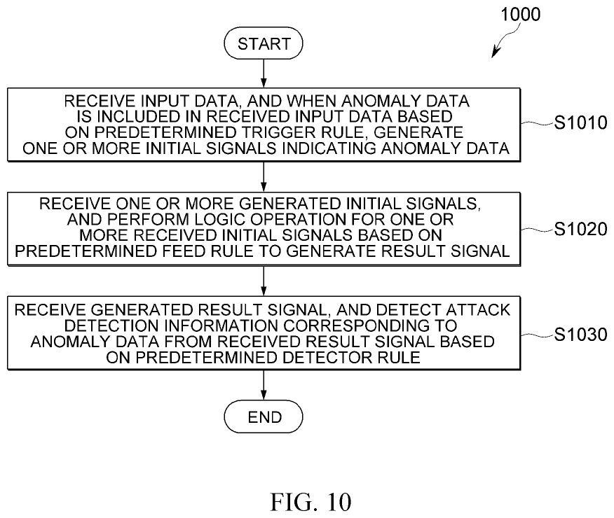

FIG. 10 is a flowchart showing an example of an anomaly data detecting method 1000 according to an embodiment of the present disclosure. According to an embodiment, the anomaly data detecting method 1000 may be performed by a processor (e.g., at least one processor of a computing device). As illustrated, the anomaly data detecting method 1000 may be initialized by receiving input data by the processor, and generating one or more initial signals indicating anomaly data when the anomaly data is included in input data received based on a trigger rule (S1010).

The processor receives one or more generated initial signals, and performs a logic operation for one or more received initial signals based on a feed rule to generate a result signal (S1020). Here, the result signal as data associated with the initial signals which becomes the target of the logic operation may refer to data including all time ranges of the initial signals.

The processor may receive the generated result signal, and detect attack detection information corresponding to the anomaly data from the received result signal based on a detector rule (S1030). For example, the attack detection information may include a name, a detection history, etc., of a detector module performing detection. Here, each of one or more detector modules may correspond to one level among a plurality of levels based on dependence of the detector module. Further, the attack detection information of a previous level of detector module may be used by a next-level detector module.

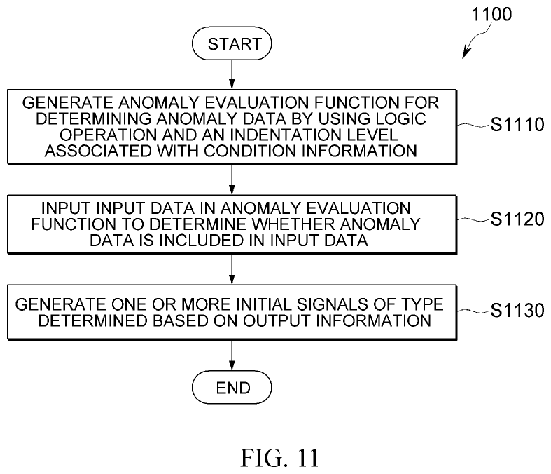

FIG. 11 is a flowchart illustrating an initial signal generating method 1100 according to an embodiment of the present disclosure. According to an embodiment, the initial signal generating method 1100 may be performed by the processor (e.g., at least one processor of the computing device). As illustrated, the initial signal generating method 1100 may be initialized by generating an anomaly evaluation function for determining the anomaly data by using a logic operation and an indentation level associated with condition information by the processor (S1110).

The processor inputs the input data in the anomaly evaluation function to determine whether the anomaly data is included in the input data (S1120). Here, the anomaly evaluation function may be generated by using the logic operation and the indentation level associated with the condition information. Further, when it is determined that the anomaly data is included, the processor may generate one or more initial signals of a type determined based on output information (S1130). Here, the output information may be associated with the type of generated initial signal.

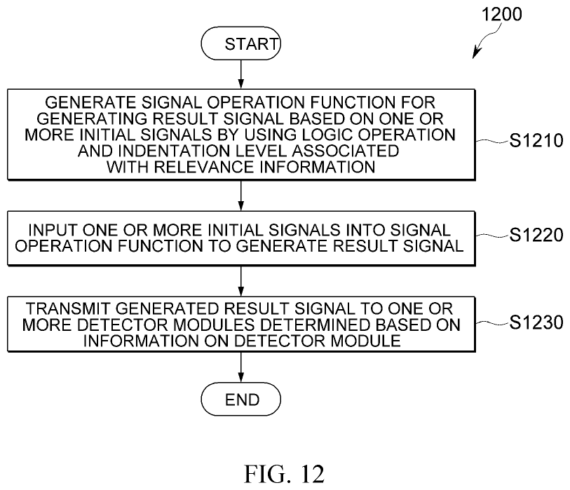

FIG. 12 is a flowchart illustrating a result signal generating method 1200 according to an embodiment of the present disclosure. According to an embodiment, the result signal generating method 1200 may be performed by the processor (e.g., at least one processor of the computing device). As illustrated, the result signal generating method 1200 may be initialized by generating a signal operation function for generating a result signal based on one or more initial signals by using a logic operation and an indentation level associated with relevance information by the processor (S1210). Here, the relevance information may include information for determining a logic relation between one or more trigger modules.

The processor inputs one or more initial signals into the signal operation function to generate the result signal (S1220). Further, the processor may transmit the generated result signal to one or more detector modules determined based on information on a detector module (S1230). Here, the information on the detector module may include predetermined information for determining the detector module receiving the generated result signal.

According to an embodiment, the processor may receive the initial signal, and remove a redundant initial signal among one or more initial signals. For example, the processor may determine initial signals generated by the same trigger module among one or more trigger modules as the redundant initial signal, and remove the redundant initial signal. In another example, the processor may determine initial signals in which anomaly ranges are redundant at a predetermined rate or more as the redundant initial signal, and remove the redundant initial signal.

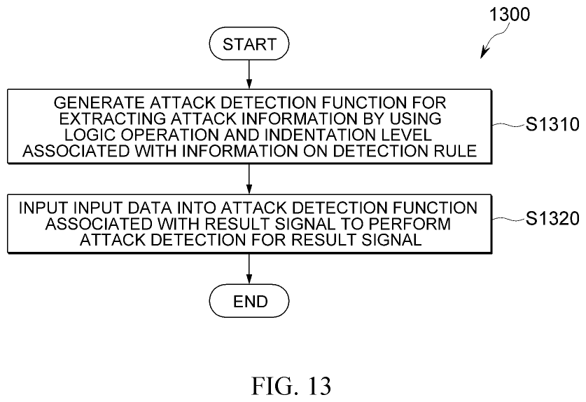

FIG. 13 is a flowchart illustrating an example of an attack detecting method 1300 according to an embodiment of the present disclosure. According to an embodiment, the attack detecting method 1300 may be performed by the processor (e.g., at least one processor of the computing device). As illustrated, the attack detecting method 1300 may be initialized by generating an attack detection function for extracting attack information by using a logic operation and an indentation level associated with information on a detection rule by the processor (S1310).

The processor may input input data into the attack detection function to perform attack detection for a result signal (S1320). In other words, the processor may generate attack detection information for the input data associated with the result signal by using the attack detection function. The generated attack detection information may be used or determining an attribute and/or a procedure of an attack or used for additional attack detection.

The method and/or various embodiments may be implemented by a digital electronic circuit, computer hardware, firmware, software, and/or a combination thereof. Various embodiments of the present disclosure may be executed by a data processing device, e.g., one or more programmable processors and/or one or more computing devices or implemented by a computer readable recording medium and/or a computer program stored in the computer readable recording medium. The computer program may be created by a predetermined type of programming language including a compiled language or an interpreted language, and distributed as a predetermined type such as an independent execution type program, a module, a subroutine, etc. The computer program may be distributed through one the computing device, a plurality of computing devices connected through the same network, and/or a plurality of computing devices distributed to be connected through a plurality of different networks.

The method and/or various embodiments may be performed by one or more processors configured to operate based on the input data or execute one or more computer programs processing, storing, and/or managing a predetermined function, a predetermined function, etc., by generating the output data. For example, the method and/or various embodiments may be performed by a special-purpose logic circuit such as a Field Programmable Gate Array (FPGA) or an Application Specific Integrated Circuit (ASIC), and a device and/or a system for performing the method and/or embodiments of the present disclosure may be implemented as the special-purpose logic circuit such as the FPGA or ASIC.

One or more processor executing the computing program may include a universal-purpose or special-purpose microprocessor and/or one or more processors of a predetermined type of digital computing device. The processor may receive a command and/or data from each of a read dedicated memory and a random access memory or receive the command and/or data from the read dedicated memory and the random access memory. In the present disclosure, components of the computing device performing the method and/or embodiments may include one or more processors for executing commands, and one or more memory devices for storing the commands and/or data.

According to an embodiment, the computing device may send and receive data to and from one or more mass storage devices for storing data. For example, the computing device may receive data from a magnetic disc or an optical disc or/and transmit the data to the magnetic disc or the optical disc. A computer readable storage medium (recording medium) suitable for storing the commands and/or data associated with the computer program may include a predetermined type of non-volatile memory including semiconductor memory devices such as an Erasable Programmable Read-Only Memory (EPROM)), an Electrically Erasable PROM (EEPROM), a flash memory device, etc., but the present disclosure is not limited thereto. For example, the computer readable storage medium may include a magnetic disc such as an internal hard disc or a mobile disc, a magneto-optic disc, a CD-ROM disc, and a DVD-ROM disc.

In order to provide an interaction with the user, the computing device may include a display device (e.g., a Cathode Ray Tube (CRT), a Liquid Crystal Display (LCD), etc.) for providing or displaying information to the user, and a pointing device (e.g., a keyboard, a mouse, a trackball, etc.) which enables the user to provide an input and/or a command onto the computing device, but the present disclosure is not limited thereto. That is, the computing device may further include other predetermined types of devices for providing the interaction with the user. For example, the computing device may provide, to the user, predetermined sense feedbacks including a visual feedback, an auditory feedback, and/or a tactile feedback for the interaction with the user. In this regard, the user may provide the input to the computing device through various gestures including visual, voice, behaviors, etc.

In the present disclosure, various embodiments may be implemented by a computing device including a backend component (e.g., a data server), a middleware component (e.g., an application server), and/or a front-end component. In this case, the components may be interconnected by a predetermined form or medium of digital data communications such as a communication network. For example, the communication network may be a (Local Area Network (LAN), a Wide Area Network (WAN), etc.

The computing device based on the exemplary embodiments described in the present specification may be implemented by using hardware and/or software configured to interact with the user, which includes a user device, a user interface (UI) device, a user terminal, or a client device. For example, the computing device may include a hand-held computing device such as a laptop computer. Additionally or alternatively, the computing device may include a Personal Digital Assistants (PDA), a tablet PC, a game console, a wearable device, an internet of things (IOT) device, a virtual reality (VR) device, an augmented reality (AR) device, etc., but the present disclosure is not limited thereto. The computing device may further include another type of device configured to interact with the user. Further, the computing device may include a hand-held communication device (e.g., a mobile phone, a smart phone, a wireless cellular phone, etc.) suitable for wireless communication through a network such as a mobile communication network, etc. The computing device may be configured to wirelessly communicate with a network server by using wireless communication technologies and/or protocols such as radio frequency (RF), microwave frequency (MWF), and/or infrared ray frequency (IRF).

In the present disclosure, if it is not contrarily defined, all terms used in the present specification including technological or scientific terms have the same meanings as those generally understood by a person with ordinary skill in the art to which such a concept belongs. Further, generally used terms such as terms defined in a dictionary should be interpreted to have a meaning which coincides with a meaning in a context of related art.

In the present specification, the present disclosure is described in relation to some embodiments, but various modifications and changes can be made within the scope without departing from the scope of the present disclosure that can be understood by those skilled in the art in the present disclosure. Further, the modifications and the changes should be regarded to be included in the appended claims of the present specification.

What is claimed is:

1. An anomaly data detecting system comprising:
one or more trigger modules receiving input data, and when anomaly data is included in the received input data based on a trigger rule, generating one or more initial signals indicating the anomaly data;
a signal hub receiving one or more generated initial signals from the one or more trigger modules, and performing a logic operation for the one or more received initial signals based on a feed rule to generate a result signal; and
one or more detector modules receiving the generated result signal from the signal hub, and detecting attack detection information corresponding to the anomaly data from the received result signal based on a detector rule.

2. The anomaly data detecting system of claim 1, wherein the trigger rule includes condition information for determining specific data as the anomaly data, and
the one or more trigger modules include an anomaly evaluation function generation module generating an anomaly evaluation function for determining the anomaly data by using a logic operation and an indentation level associated with the condition information.

3. The anomaly data detecting system of claim 2, wherein the one or more trigger modules further include an anomaly checker module receiving the generated anomaly evaluation function from the anomaly evaluation function generation module, and inputting the input data into the anomaly evaluation function, and when the anomaly data is included in the input data, transmitting an initial signal generation request.

4. The anomaly data detecting system of claim 3, wherein the trigger rule further includes output information associated with a type of generated initial signal, and
the one or more trigger modules further include a signal generation module generating one or more initial signals of a type determined based on the output information when receiving the initial signal generation request from the anomaly checker module.

5. The anomaly data detecting system of claim 1, wherein the trigger rule input information associated with a feature of the input data, and
the one or more trigger modules include a data reception module receiving the input data by using a target protocol from a specific location of a database determined based on the input information.

6. The anomaly data detecting system of claim 1, wherein the feed rule includes relevance information for determining a logic relation between the one or more trigger modules, and
the signal hub includes a signal operation function generation module generating a signal operation function for generating the result signal based on one or more initial signals by using the logic operation and the indentation level associated with the relevance information.

7. The anomaly data detecting system of claim 6, wherein the signal hub further includes a signal operation module receiving the generated signal operation function from the signal operation function generation module, and generating the result signal by inputting the one or more initial signals into the signal operation function.

8. The anomaly data detecting system of claim 1, wherein the signal hub includes a signal reducer for removing a redundant initial signal among the one or more initial signals.

9. The anomaly data detecting system of claim 7, wherein the signal reducer determines initial signals generated by the same trigger module among the one or more trigger modules as the redundant initial signal.

10. The anomaly data detecting system of claim 7, wherein the signal reducer determines initial signals in which anomaly ranges are redundant at a predetermined rate or more as the redundant initial signal.

11. The anomaly data detecting system of claim 1, wherein the feed rule includes information on a detector module for determining a detector module receiving the generated result signal, and
the signal hub includes a signal transmission module transmitting the generated result signal to the one or more detector module determined based on the information on the detector module.

12. The anomaly data detecting system of claim 1, wherein the detector rule includes information on a detection rule for extracting attack information associated with the anomaly data, and
the one or more detector modules include an attack detection function generation module generating an attack detection function for extracting the attack information by using the logical operation and the indentation level associated with the information on the detection rule.

13. The anomaly data detecting system of claim 12, wherein the one or more detector modules further include an attack detection module receiving the generated attack detection function from the attack detection function generation module and inputting the input data associated with the result signal into the attack detection function to perform attack detection for the result signal.

14. The anomaly data detecting system of claim 1, wherein the detector rule includes relevance information between the one or more detector modules for determining whether to process the attack detection information, and
the one or more detector modules include an evaluation function generation module generating an evaluation function for determining whether to process the attack detection information by using the logical operation and the indentation level associated with the relevance information.

15. The anomaly data detecting system of claim 14, further comprising:
wherein each of the one or more detector modules corresponds to one level among a plurality of levels based on dependence of the detector module, and
wherein the attack detection information of a previous level of detector module is used by a next-level detector module,
an evaluation module receiving the generated evaluation function from the generated evaluation function generation module, and transmitting the attack detection information to the next-level detector module or a backtracker module based on the received evaluation function.

16. The anomaly data detecting system of claim 15, wherein when there is the next-level detector module, the evaluation module transmits the attack detection information to the next-level detector module based on the evaluation function.

17. The anomaly data detecting system of claim 15, wherein when there is no next-level detector module, the evaluation module transmits the attack detection information to the backtracker module.

18. The anomaly data detecting system of claim 1, further comprising:
a backtracker module determining an attribute of the attack and a procedure of the attack associated with the anomaly data by using the attack detection information of the one or more detector modules.

19. An anomaly data detecting method performed by at least one processor, comprising:
receiving input data, and when anomaly data is included in the received input data based on a trigger rule, generating one or more initial signals indicating the anomaly data;
receiving the one or more generated initial signals, and performing a logic operation for the one or more received initial signals based on a feed rule to generate a result signal; and
receiving the generated result signal, and detecting attack detection information corresponding to the anomaly data from the received result signal based on a detector rule.

20. A computer program stored in a computer readable recording medium to allow a computer to execute the anomaly data detecting method of claim 19.
